(19) United States
(12) Patent Application Publication
(10) Pub. No.: US 2005/0286701 A1
(43) Pub. Date: Dec. 29, 2005

(54) Call attempt handling in a communication system

(75) Inventors: Martti Suvanne, Ylikiiminki (FI); Andrew Strawn, Fleet (GB); Brian Davidson, Woking (GB)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/874,904

(22) Filed: Jun. 23, 2004

(51) Int. Cl. H04M 3/42

(52) U.S. Cl. 379/207.11

(57) ABSTRACT

The present invention relates to a method for call attempt handling in a communication system. The method comprises receiving a call attempt directed to a user terminal, the call attempt being initiated by a calling party. Furthermore, the method comprises verifying whether an override function is set relating to said user terminal. Furthermore, the method comprises verifying whether a correct override code is given by the calling party. Furthermore, the method comprises allowing a call-arriving signal to be created in the user terminal overriding settings preventing creation of the call-arriving signal, when the override function is set and the correct override code is given. Furthermore, the present invention relates to a user terminal and a switching point adapted to embodiments of the invention.

### FIELD OF THE INVENTION

The invention relates to communication systems, and more particularly to call attempt handling in a communication system.

### BACKGROUND OF THE INVENTION

A communication system can be seen as a facility that enables communication sessions between two or more entities such as user equipment and/or other nodes associated with the communication system. Users of a communication system may be offered and provided numerous services, such as two-way or multi-way calls, data communication or multimedia services or simply an access to a network, such as the Internet. The services may be offered by an operator of the communication system or by an external service provider.

Examples of communication systems may include fixed line communication systems, such as a public switched telephone network (PSTN), wireless communication systems, e.g. global system for mobile communications (GSM), general packet radio service (GPRS), universal mobile telecommunications system (UMTS), wireless local area network (WLAN) and so on, and/or other communication networks, such as an Internet Protocol (IP) network and/or other packet switched data networks. Various communication systems may simultaneously be concerned in a connection.

A user may access a communication network by means of any appropriate user equipment (UE) or user terminal, for example a mobile terminal, such as a mobile station (MS), a cellular phone, a personal digital assistant (PDA) or the like, or other terminals, such as a personal computer (PC), or any other equipment operable according to a suitable network protocol, such as a wireless applications protocol (WAP) or a hypertext transfer protocol (HTTP). One skilled in the art is familiar with the features and operation of a typical user terminal. Thus, it is sufficient to note that a user may use user terminals for tasks such as for making and receiving phone calls, for receiving and sending data from and to the network and for experiencing multimedia content or otherwise using multimedia services. Examples of services that a user terminal may support may include, but are not limited to short message service (SMS), multimedia message service (MMS), electronic mail (email), Web service interface (WSI) messaging and voice mail.

A user terminal may include an antenna for wirelessly receiving and transmitting signals from and to base stations of a mobile communication network. A user terminal may be provided with a display for displaying images and other graphical information for the user of the user terminal. Camera means may be provided for capturing still or video images. Speaker means are also typically provided. The operation of a user terminal may be controlled by means of an appropriate user interface such as control buttons, voice commands and so on. Furthermore, a user terminal is provided with a processor entity and memory means. Recoding means may be provided for recording messages, portions of a call and so on.

Typically, it is possible to set a user terminal in different modes for various purposes, such as for receiving calls. It may be possible to select whether call-arriving signals are provided by alarming aloud, such as ringing or beeping, or by means of a vibrating alarm. It may be possible to set a user terminal in a silent mode, such that a notification of an incoming call is only displayed on the display of the user terminal. Displaying may take place during the call attempt and the notification may be stored in the memory means of the user terminal after the call attempt. The notification may be displayed to the user automatically or upon a request, for example.

It may also be possible for a user of user terminal to select a predefined calling number to be handled in a predetermined manner. An example may include selecting a predetermined call-arriving signal, such as a predetermined ringing tone, for notifying about an incoming call from a predefined calling number.

It may also be possible to override the silent mode when an incoming call is received from a predefined calling number. A calling number may be assigned to a specific group in settings stored in the memory of the user terminal. In the silent mode setting, it may be possible to select that a call attempt from the calling number belonging to the specific group is allowed to alert aloud, while all other call attempts are set to alert silently.

A user terminal may support voice mail service provided by a service provider, such as a network operator, via the communication system. The voice mail service may provide means for receiving a voice message from a calling party when a call cannot be answered. The voice mail may be activated in accordance with predetermined rules. It may be possible to determine that all incoming calls are routed to the voice mail service. In an alternative, it may be possible to determine that a call attempt is first routed to user terminal and, if not answered, rerouted to the voice mail service after a call attempt has lasted for a predetermined period of time, such as after a predetermined number of call-arriving signals. In a further alternative, it may be possible to determine that a call is routed to the voice mail service if the user terminal cannot be reached, for example if the user terminal is not under radio coverage.

Call forwarding is a function for rerouting incoming calls to another number in the communication systems. When a user requires calls coming to his primary number to be rerouted to a second number, the user may activate call forwarding. Call forwarding may be unconditional so that a call is always transferred to the second number the user has activated. It is also possible to set a conditional call forwarding so that a call is transferred to the second number if the primary number is occupied, does not respond or is not under radio coverage.

In some cases, it may be desirable to be able to separate different types of calls. As described above, the called party, i.e. a user of user terminal receiving a call attempt, may set the user terminal in different modes for receiving call attempts. The modes may even be selected differently for different calling parties as was explained above. An example may comprise allowing call attempts from the particular calling numbers be routed to a user terminal of the called party, even if all other call attempts are to be routed to the voice mail service. Another example may be allowing a call-arriving signal to be created even if a silent mode is set in the user terminal when call attempts are received from the particular calling numbers. Conventionally, all the call attempts from the particular numbers would be handled in the predetermined manner determined by the called party, irrespective of an importance of a matter related to the call attempt. For example, call attempts from the calling number belonging to a child of the user may be determined such that they are directed to the user terminal of the user and a call-arriving signal is given even if a silent mode or voice mail service were set. Thus in the state of the art, a call just to say hello is handled in the same predetermined manner as a very urgent call. The calling party is typically bound to the settings activated by the called party.

Therefore, there is a need for improved ways of selecting different manners in receiving call attempts. It may be desirable to provide also a calling party a possibility to affect on a call attempt handling.

It shall be appreciated that these issues are not limited to any particular communication environment, but may occur in any appropriate communication system.

### SUMMARY OF THE INVENTION

Embodiments of the invention aim to address one or several of the above problems or issues.

In accordance with an aspect of the invention, there is provided a method for call attempt handling in a communication system. The method comprises receiving a call attempt directed to a user terminal, the call attempt being initiated by a calling party. Furthermore, the method comprises verifying whether an override function is set relating to said user terminal. Furthermore, the method comprises verifying whether a correct override code is given by the calling party. Furthermore, the method comprises allowing a call-arriving signal to be created in the user terminal overriding settings preventing creation of the call-arriving signal, when the override function is set and the correct override code is given.

In accordance with another aspect of the invention, there is provided a user terminal configured to receive a call attempt directed to the user terminal, the call attempt being initiated by a calling party, to verify whether an override function is set, to verify whether a correct override code is given by the calling party and to allow a call-arriving signal to be created in the user terminal overriding settings preventing creation of the call-arriving signal, when the override function is set and the correct override code is given.

In accordance with another aspect of the invention, there is provided a switching point in a communication system configured to receive a call attempt directed to a user terminal served by the switching point, the call attempt being initiated by a calling party, to verify whether an override function is set relating to said user terminal, to verify whether a correct override code is given by the calling party and to allow a call-arriving signal to be created in the user terminal overriding settings preventing creation of the call-arriving signal, when the override function is set and the correct override code is given.

Further embodiments become clear from the following detailed description and the appended claims.

### BRIEF DESCRIPTION OF THE DRAWINGS

The invention will now be described in further detail, by way of example only, with reference to the following examples and accompanying drawings, in which:

FIG. 1 shows an example of an arrangement in which the embodiments of the invention may be implemented;

FIG. 2 shows a flow chart illustrating an embodiment of the invention;

FIG. 3 shows a flow chart illustrating a further embodiment of the invention; and

FIG. 4 shows a flow chart illustrating a further embodiment of the invention.

### DETAILED DESCRIPTION OF PREFERRED EMBODIMENTS

The present invention provides a calling party a possibility to affect on handling a call attempt. Caller initiated override functionality is proposed by means of an override code, such as a predetermined number string, a password, a personal identification number or another appropriate code.

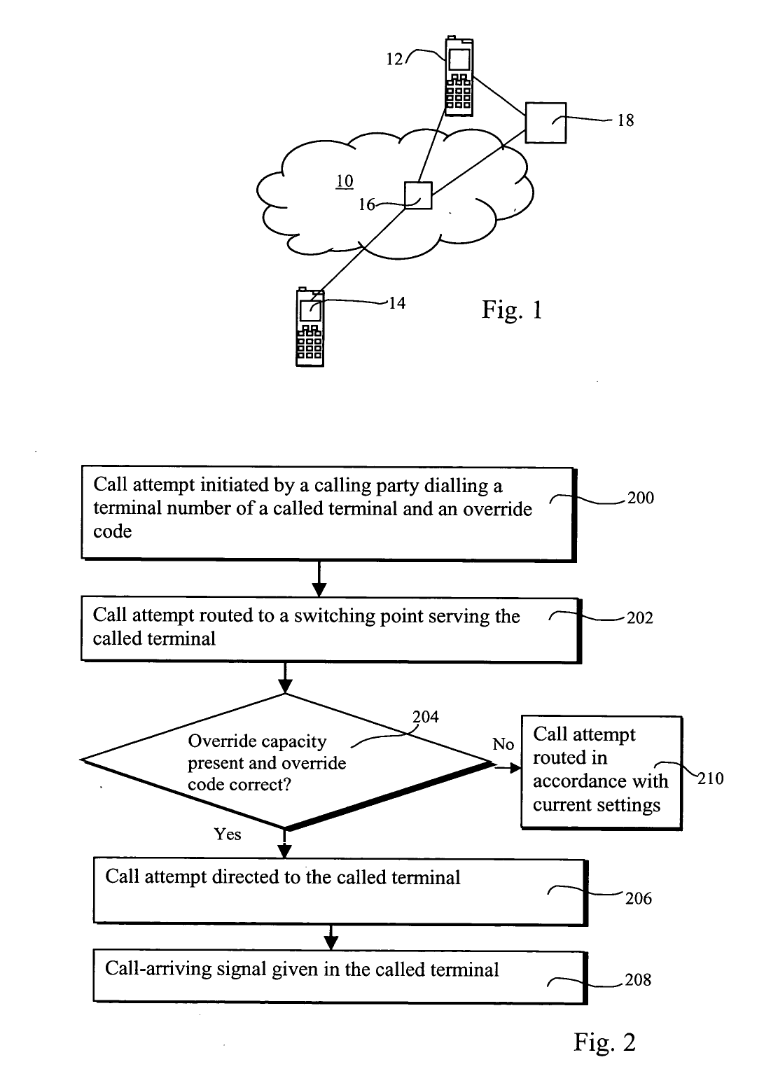

FIG. 1 shows an example of an arrangement including a communication network 10, a calling user terminal 12 and a called user terminal 14. Furthermore, FIG. 1 shows a switching point 16 via which call attempts may be routed from the calling user terminal 12 to the called user terminal 14. Furthermore, FIG. 1 shows a voice mail service 18 which may relate to the called user terminal 14.

It shall be appreciated that FIG. 1 is only an example showing two mobile user terminals, one switching point and a voice mail service. The number and type of these entities may differ substantially from that which is shown. Typically, a communication system comprises numerous switching points of different types. One or more of the user terminals may be fixed terminals. Various other services in addition to the voice mail service may be provided via the communication system. The communication network 10 may be any appropriate communication network. In an embodiment, the communication network 10 is provided at least in part by a mobile telecommunications network.

FIG. 2 shows a flowchart illustrating an embodiment of the invention. In step 200, a calling party dials a terminal number and additionally an override code to initiate a call attempt. The override code may be a string of numbers or the like specific for the terminal number in question. The override code may be given by a user of the terminal beforehand to a selected calling party, for example by means of an SMS, letter, verbal communication and so on. The override code may be the same for all calling parties or different for each calling party.

In step 202, the call attempt is routed to a switching point serving the terminal relating to the dialled terminal number, i.e. a called terminal. The switching point may be an appropriate node in the network, such as a switching centre, a mobile switching centre (MSC), a service switching point (SSP), and so on, depending on the communication system.

In step 204, it is verified, in the switching point, whether an override capacity is present for the called terminal and whether the override code is correct. The user of the called terminal or another appropriate party, such as an operator, has determined in advance the override capacity and informed the switching point accordingly.

In step 206, when the override capacity is present and a correct override code was given, the switching point routes the call attempt to the called terminal irrespective of a voice mail service setting. In an embodiment, the user of the called terminal may determine that the override code should also override call forwarding setting or the like.

In step 208, a call-arriving signal is given in the called terminal.

In step 210, when the override capacity is not present or an override code is not given or the given override code was not correct, the switching point routes the call attempt in accordance to current settings, such as to a voice mail service or to another number.

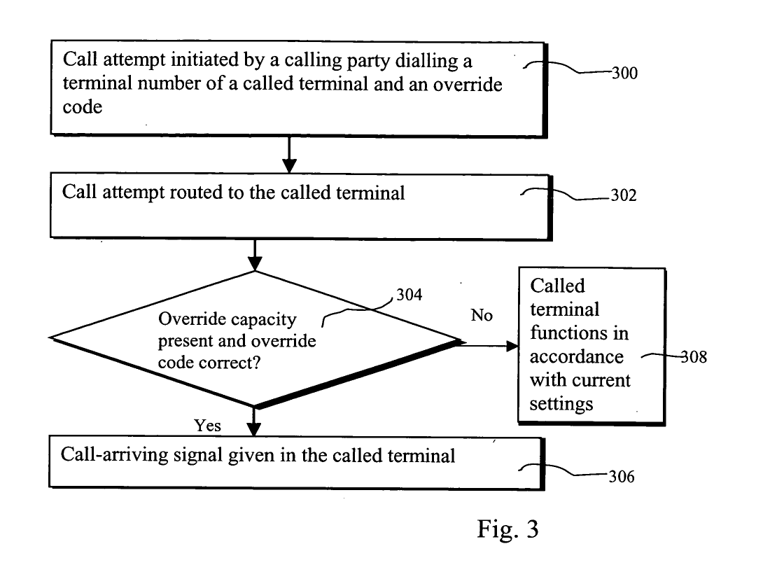

FIG. 3 shows a flowchart illustrating a further embodiment of the invention. In step 300, a calling party dials a terminal number and an override code to initiate a call attempt. In step 302, the call attempt is routed from the calling terminal to the terminal relating to the dialled terminal number, i.e. a called terminal. In step 304, the called terminal verifies whether an override capacity is present and whether a given override code is correct. The user of the called terminal may have determined in advance the override capacity and set the capacity in the called terminal accordingly. In an embodiment, the override capacity may be pre-set in the terminal, for example already during manufacture or by a vendor or an operator. In an embodiment, an operator or another party may provide automatic configuration of the terminal introducing the override capacity in the terminal. In step 306, when the override capacity is present and a correct override code was given, any silent mode or similar setting is overridden and a call-arriving signal is given in the called terminal. In step 308, when the override capacity is not present or an override code is not given or the given override code was not correct, the called terminal functions in accordance with the current setting, such as the silent mode.

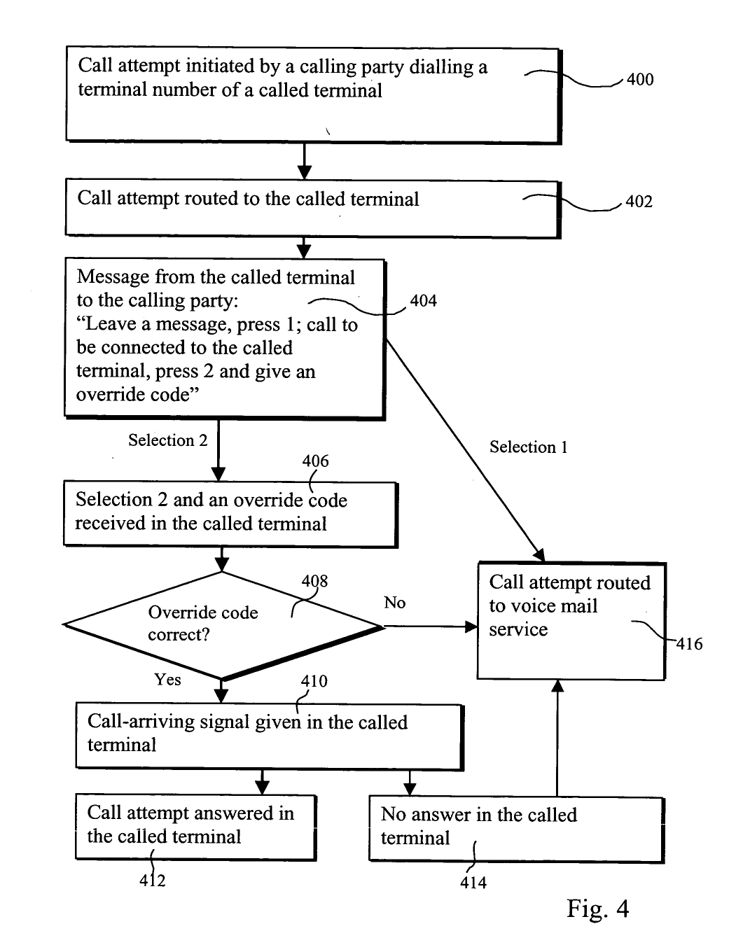

FIG. 4 shows a flowchart illustrating a further embodiment of the invention. In step 400, a calling party dials a terminal number to initiate a call attempt. In step 402, the call attempt is routed from the calling terminal to the terminal relating to the dialled terminal number, i.e. a called terminal. In step 404, the called terminal outputs a message recorded in the recoding means to be heard by the calling party. The message may comprise selectable alternatives, such as leaving a message or continuing the call attempt by giving a call-arriving signal in the called terminal. The message may have, for example, the following form: “I am in a meeting. If you wish to leave a message, press 1. If you wish the call be connected to me immediately, press 2 and give an override code.”

In step 406, the called terminal receives a selection for the alternative 2 together with an override code given by the calling party by means of a keyboard of the calling terminal, a voice indication, such as a password, or another appropriate code. In step 408, the called terminal verifies whether the given override code was correct. In step 410, when the override code was correct, a call-arriving signal is given in the called terminal. In step 412, a user of the called terminal may answer the call. In an alternative step 414, the user may select not to answer and the call attempt to routed to a voice mail service. The selection may be performed by touching or pressing a predetermined button or sign in a user interface or by a voice command or in another appropriate manner. In an embodiment, the selection may be automatic such that after a predetermined period of time, if the call attempt is not answered, the selection is made.

In step 416, when the calling party selected the alternative 1 for leaving a message or when an override code was not given or when the given override code was not correct or when the user selected not to answer the call attempt, the terminal routes the call attempt to a voice mail service.

In an embodiment, it may determined that a call attempt is to be routed to a third terminal, such as a terminal of a secretary, instead of the voice mail service as described in FIG. 4. The call attempt may then be rerouted to the third person by means of call forwarding. In an alternative, a conference may be created between the calling party, the called party and the third party. The audio means, such as the speaker, of the called terminal may remain switched off even if the called terminal is a party of the conference. In this embodiment, the calling party may be given an additional or alternative selectable alternative in the message, such as “If you wish to speak to my secretary, press 3.”

The override code may be ruled such that only one or a part of terminal settings, such as silent mode, voice mail or call forwarding, is overridden.

In an embodiment, a single terminal may be related to two or more terminal numbers. A user of the terminal may use one or more selected terminal numbers for predetermined purposes, such as emergency calls. It may be determined that calls coming to the selected terminal number(s) are allowed to be connected to the terminal. One or more of the above embodiments may be used together with the embodiment using a plurality of terminal numbers in the single terminal.

Embodiments of the present invention may be useful in various situations where it may be desirable to provide a calling party a possibility to select how a call attempt is handled. Examples may include, but are not limited to, giving an override authority to a close person. For example, the wife of the user is about to give a birth. She may override any silent mode or voice mail, as she has been given an override authority if she needs to contact the user quickly. Another example may be an employer of the user who needs to call the user for an emergency meeting. Further examples may include a doctor who is expected to inform about important results or other persons authorised by the user. The user may give calling parties a permanent override authorisation or authorise overriding for a predetermined period or even just for once.

Although the invention has been described in the context of particular embodiments, various modifications are possible without departing from the scope and spirit of the invention as defined by the appended claims. It should be appreciated that whilst embodiments of the present invention have mainly been described in relation to mobile terminals, embodiments of the present invention may be applicable to other types of user equipment that may access communication networks. Furthermore, the communication system may be any appropriate communication system, even if reference has mainly been made to mobile communication systems.

1. A method for call attempt handling in a communication system, the method comprising:
receiving a call attempt directed to a user terminal, the call attempt being initiated by a calling party;
verifying whether an override function is set relating to said user terminal;
verifying whether a correct override code is given by the calling party; and
allowing a call-arriving signal to be created in the user terminal overriding settings preventing creation of the call-arriving signal, when the override function is set and the correct override code is given.

2. A method according to claim 1, wherein the step of receiving the call attempt comprises receiving the call attempt in a switching point serving said user terminal.

3. A method according to claim 2, further comprising setting the override function in the switching point.

4. A method according to claim 2, wherein the steps of verifying are performed in the switching point.

5. A method according to claim 4, wherein the step of allowing comprises overriding a voice mail setting.

6. A method according to claim 1, further comprising setting the override function in the user terminal by a user of the user terminal.

7. A method according to claim 1, wherein the override function is pre-set in the user terminal.

8. A method according to claim 1, wherein the steps of verifying are performed in the user terminal.

9. A method according to claim 8, wherein the step of allowing comprises overriding a silent mode setting.

10. A method according to claim 1, wherein the step of verifying whether the override function is set comprises outputting from the user terminal a message to be heard by the calling party.

11. A method according to claim 10, wherein the step of outputting the message comprises providing the calling party selectable alternatives as how to proceed with the call attempt.

12. A method according to claim 11, wherein the selectable alternatives comprise causing a call-arriving signal to be created in the user terminal and forwarding the call attempt to a third entity.

13. A method according to claim 12, wherein the selectable alternative of forwarding the call attempt to a third entity comprises forwarding the call attempt to a voice mail or forwarding the call attempt to a third terminal number.

14. A method according to claim 1, wherein the step of verifying whether a correct override code is given comprises whether a predetermined number string or password is given.

15. A computer program embodied on a computer-readable medium, said computer program configured to control a computer to perform the steps of:
receiving a call attempt directed to a user terminal, the call attempt being initiated by a calling party;
verifying whether an override function is set relating to said user terminal;
verifying whether a correct override code is given by the calling party; and
allowing a call-arriving signal to be created in the user terminal overriding settings preventing creation of the call-arriving signal, when the override function is set and the correct override code is given.

16. A user terminal configured to:
receive a call attempt directed to the user terminal, the call attempt being initiated by a calling party;
verify whether an override function is set;
verify whether a correct override code is given by the calling party; and
allow a call-arriving signal to be created in the user terminal overriding settings preventing creation of the call-arriving signal, when the override function is set and the correct override code is given.

17. A user terminal according to claim 16, configured to override a silent mode setting.

18. A user terminal according to claim 16, configured to output a message to be heard by the calling party.

19. A user terminal according to claim 18, configured to provide the calling party selectable alternatives as how to proceed with the call attempt.

20. A user terminal according to claim 19, wherein the selectable alternatives comprise causing a call-arriving signal to be created in the user terminal and forwarding the call attempt to a third entity.

21. A user terminal according to claim 20, wherein the selectable alternative of forwarding the call attempt to a third entity comprises forwarding the call attempt to a voice mail or forwarding the call attempt to a third terminal number.

22. A user terminal according to claim 16, wherein the correct override code comprises a predetermined number string or password.

23. A user terminal according to claim 22, wherein the predetermined number string or password is assigned for calling parties selected by a user of the user terminal.

24. A user terminal according to claim 23, wherein the predetermined number string or password is the same for all the selected calling parties.

25. A user terminal according to claim 23, wherein the predetermined number string or password is different for each selected calling party.

26. A user terminal according to claim 16, configured to allow a user to set the override function.

27. A user terminal according to claim 16, wherein the override function is pre-set.

28. A user terminal comprising:
means for receiving a call attempt directed to the user terminal, the call attempt being initiated by a calling party;
means for verifying whether an override function is set;
means for verifying whether a correct override code is given by the calling party; and
means for allowing a call-arriving signal to be created in the user terminal overriding settings preventing creation of the call-arriving signal, when the override function is set and the correct override code is given.

29. A switching point in a communication system configured to:
receive a call attempt directed to a user terminal served by the switching point, the call attempt being initiated by a calling party;
verify whether an override function is set relating to said user terminal;
verify whether a correct override code is given by the calling party; and
allow a call-arriving signal to be created in the user terminal overriding settings preventing creation of the call-arriving signal, when the override function is set and the correct override code is given.

30. A switching point according to claim 24, configured to override a voice mail setting.

31. A switching point according to claim 24, configured to receive setting of the override function from said user terminal or from an operator relating to said user terminal.

32. A switching point in a communication system comprising:
means for receiving a call attempt directed to a user terminal served by the switching point, the call attempt being initiated by a calling party;
means for verifying whether an override function is set relating to said user terminal;
means for verifying whether a correct override code is given by the calling party; and
means for allowing a call-arriving signal to be created in the user terminal overriding settings preventing creation of the call-arriving signal, when the override function is set and the correct override code is given.
